(19) United States
(12) Patent Application Publication
(10) Pub. No.: US 2017/0366862 A1
(43) Pub. Date: Dec. 21, 2017

(54) CONTENT RECOMMENDATION USER INTERFACE

(71) Applicant: THOMSON LICENSING, Issy Les Moulineaux (FR)

(72) Inventors: Arden A. ASH, Los Angeles, CA (US); Victor WANG, Los Angeles, CA (US)

(21) Appl. No.: 15/535,058

(22) PCT Filed: Dec. 4, 2015
(86) PCT No.: PCT/US2015/063873

§ 371 Date: Jun. 11, 2017

Related U.S. Application Data
(60) Provisional application No. 62/090,460, filed on Dec. 11, 2014.

(51) Int. Cl. H04N 21/482; G06F 3/0484; G06F 17/30; H04N 21/84

(52) U.S. Cl. CPC H04N 21/4826; H04N 21/84; G06F 3/04842; G06F 17/30035; G06F 17/30061

(57) ABSTRACT

A computing device presents a user interface in which graphical representations of content may be positioned based on user input. Inclusionary and exclusionary portions of metadata associated with the content may be ranked based on the positions and/or positional relationships of the graphical representations in the user interface. The computing device generates content recommendations based on the rankings. Presented content associated with the content recommendations may be provided to a user in response to selection of a content recommendation. The content recommendations may be modified in response to changes to the user interface received from a user.

### TECHNICAL FIELD OF THE INVENTION

Embodiments described herein relate generally to content delivery systems and, more particularly, to a user interface for generating content recommendations.

### BACKGROUND OF THE INVENTION

Conventional content delivery systems, such as cable, satellite television, or Internet content systems, typically transmit content (such as movies, television programs, images, music, and so on) from one or more computing devices (such as a head end) of a content provider to one or more content receivers (such as a set top box, home computer, and so on). Often, such a content delivery system may be able to delivery specific content in response to a user's request, or “on demand.”

However, on demand content delivery systems may have a great deal of content available. Though having a large amount of content available for providing may be beneficial for users, users may have difficulty finding the content they wish to obtain within all of the content that is available.

In some cases, the content that is available may be searchable by a user. However, such searching may be burdensome and time consuming for the user. Further, the user may have difficulty finding the content the user is looking for. This may be exacerbated when a user is not entirely sure what content the user wishes to obtain.

In various cases, content may be suggested to a user, such as based on various data in the user's profile and/or the user's previous content access habits. However, prediction of content that a user may wish to access may not be particularly customizable by a user. As such, the user may be presented with content that is suited to their tastes, but is not what they particularly wish to find at that particular time.

Accordingly, there may be a present need for generating recommendations in an on demand content delivery system.

### SUMMARY

This summary is provided to introduce a selection of concepts in a simplified form that are further described below in the Description of the Embodiments section below. This summary is not intended to identify key features or essential features of the claimed subject matter, nor is it intended to be used as an aid in determining the scope of the claimed subject matter.

Embodiments described herein may relate to, include, or take the form of methods, systems, and apparatuses for generating content recommendations. A computing device presents a user interface in which graphical representations of content may be positioned based on user input. The computing device ranks inclusionary and exclusionary portions of metadata associated with the content based on the positions and/or positional relationships of the graphical representations in the user interface. The computing device generates content recommendations based on the rankings. Presented content associated with the content recommendations may be provided to a user in response to selection of a content recommendation. The content recommendations may be modified in response to changes to the user interface received from a user. In this way, content recommendations may be generated in a manner that is controllable by a user without overly burdening the user.

Various embodiments described herein may relate to, include, or take the form of a method for generating a content recommendation. The method may include the operations of obtaining, utilizing a computing device, a ranking of an inclusionary portion of metadata derived from instances of content for which graphical representations are presented in a user interface and an exclusionary portion of the metadata, the metadata ranked based on positions of the graphical representations in the user interface; and generating a content recommendation utilizing the computing device based on the ranking of the inclusionary portions of the metadata and the exclusionary portions of the metadata.

Other embodiments described herein may relate to, include, or take the form of a computing device. The computing device, and more specifically, the memory of the computing device may store instructions which, when executed by a processor of the computing device may perform one or more of the methods described herein. Such a method may include obtaining a ranking of an inclusionary portion of metadata derived from instances of content for which first graphical representations are presented in an inclusion region of a user interface and an exclusionary portion of the metadata derived from instances of content for which second graphical representations are presented in an exclusion region of the user interface, the metadata ranked based on positions of the first and second graphical representations in the user interface; generating a content recommendation based on the ranking of the inclusionary metadata and the ranking of the exclusionary metadata.

Related embodiments described herein described herein may take the form of a computer program product tangibly embodied in a non-transitory computer-readable storage medium. More particularly, the computer-readable storage medium may include computer executable instructions which, when executed by at least one processor, may perform one or more of the methods described herein. In some embodiments, the computer-readable storage medium may include: a first set of instructions, stored in the non-transitory computer-readable storage medium, executable by a processing unit to provide a user interface; a second set of instructions, stored in the non-transitory computer-readable storage medium, executable by the processing unit to position graphical representations of instances of content in the user interface according to input received from a user; and a third set of instructions, stored in the non-transitory computer-readable storage medium, executable by the processing unit to generate a content recommendation based on rankings of inclusionary metadata and exclusionary metadata associated with the instances of content, the rankings determined based on the positions of the graphical representations in the user interface

### BRIEF DESCRIPTION OF THE FIGURES

Reference will now be made to representative embodiments illustrated in the accompanying figures. It is understood that the following descriptions are not intended to limit the disclosure a particular embodiment or a set of particular embodiments. To the contrary, this disclosure is intended to cover alternatives, modifications, and equivalents as may be included within the spirit and scope of the described embodiments as defined by the appended claims and as illustrated in the accompanying figures:

FIG. 1 depicts a block diagram of an example content delivery system configured for generating content recommendations;

FIGS. 2A-2G depict diagrams of a sample user interface for generating content recommendations;

FIG. 3 depicts a method diagram illustrating operations of a first example method of generating content recommendations; and

FIG. 4 depicts a flow chart illustrating operations of a second example method of generating content recommendations.

The use of the same or similar reference numerals in different drawings indicates similar, related, or identical items.

### DESCRIPTION OF THE EMBODIMENTS

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. The following detailed description is, therefore, not to be taken in a limiting sense.

Many embodiments described herein relate to methods, systems, and apparatuses for generating content recommendations. A computing device presents a user interface in which graphical representations of content may be positioned based on user input. Inclusionary and exclusionary portions of metadata associated with the content may be ranked based on the positions and/or positional relationships of the graphical representations in the user interface. The computing device generates content recommendations based on the rankings. Presented content associated with the content recommendations may be provided to a user in response to selection of a content recommendation. The content recommendations may be modified in response to changes to the user interface received from a user. In this way, content recommendations may be generated in a manner that is controllable by a user without overly burdening the user.

The metadata may be any kind of information describing the instances of content. The metadata may be stored within and/or separate from the instances of content. Such metadata may include categories of instances of content, titles of the instances of content, names of people associated with instances of content (such as directors, writers, actors, and so on), descriptions of the instances of content, episode identifiers of the instances of content, season identifiers of the instances of content, album identifiers of the instances of content, content ratings of the content, and/or any other information describing the instances of content.

In many embodiments, the user interface may include an inclusion region and an exclusion region. Metadata to include when recommending content (“inclusionary metadata”) may be derived from instances of content whose graphical representations are located in the inclusion region whereas metadata to exclude when recommending content (“exclusionary metadata”) may be derived from instances of content whose graphical representations are located in the exclusion region. Inclusionary metadata may be ranked higher when associated with a graphical representation located closer in a direction to a strong association position of the inclusion region than when located further and/or when the graphical representation is more proximate to another graphical representation located closer to the strong association position than when less proximate. Similarly, exclusionary metadata may be ranked higher when associated with a graphical representation located closer in a direction to a strong disassociation position of the exclusion region than when located further and/or when the graphical representation is more proximate to another graphical representation located closer to the strong disassociation position than when less proximate.

In various embodiments, graphical representations of multiple instances of content may be grouped together in the user interface. When grouped, the metadata that is common to members of the group may be treated as if it were the set of metadata for a single instance of content.

In some embodiments, the instance of content graphically represented in the user interface may be selected by a user from available content and/or content representations. In some cases, the user may be able to provide content that may be graphically represented in the user interface (such as by uploading from the user's computer, phone, or other device). In various implementations, the user interface may enable the user to modify, add, or remove metadata associated with one or more of the instances of content via the respective graphical representation.

In one or more embodiments, the metadata derived from the graphical representations in the user interface may be presented via the user interface, such as via a ranked list. The ranked list may indicate whether or not the metadata is to be used for a search or excluded from a search (such as by check boxes) and this indication may be modified by a user. In various implementations, a user may be able to add metadata to include and/or exclude separately from that derived via the graphical representations.

In various embodiments, not all metadata associated with instances of content for which graphical representations are included in the user interface may be utilized (either for inclusion or exclusion). Instead, in some implementations various numbers (such as five or ten) of metadata items most common to the instances of content graphically represented may be utilized (such as for inclusion, exclusion, or both). In various implementations, metadata associated with more instances of content graphically represented may be ranked higher than metadata associated with fewer instances of content graphically represented.

In many implementations, the ranking of an item of metadata may be related to a location of the graphical representation of an associated instance of content along a first direction. In such implementations, a set of metadata not common to instances of content corresponding to graphical representations positioned along a second, perpendicular direction (a disjoined set) may be treated as a set of metadata for a single instance of content.

In various implementations, the user interface may be modified after a content recommendation is provided. Such modifications may include adding graphical representations of content, repositioning graphical representations of content, removing graphical representations of content, modifying metadata, adding metadata, removing metadata, and/or any other such modification. Upon modification of the user interface, a new content recommendation may be generated and presented based upon the modified user interface.

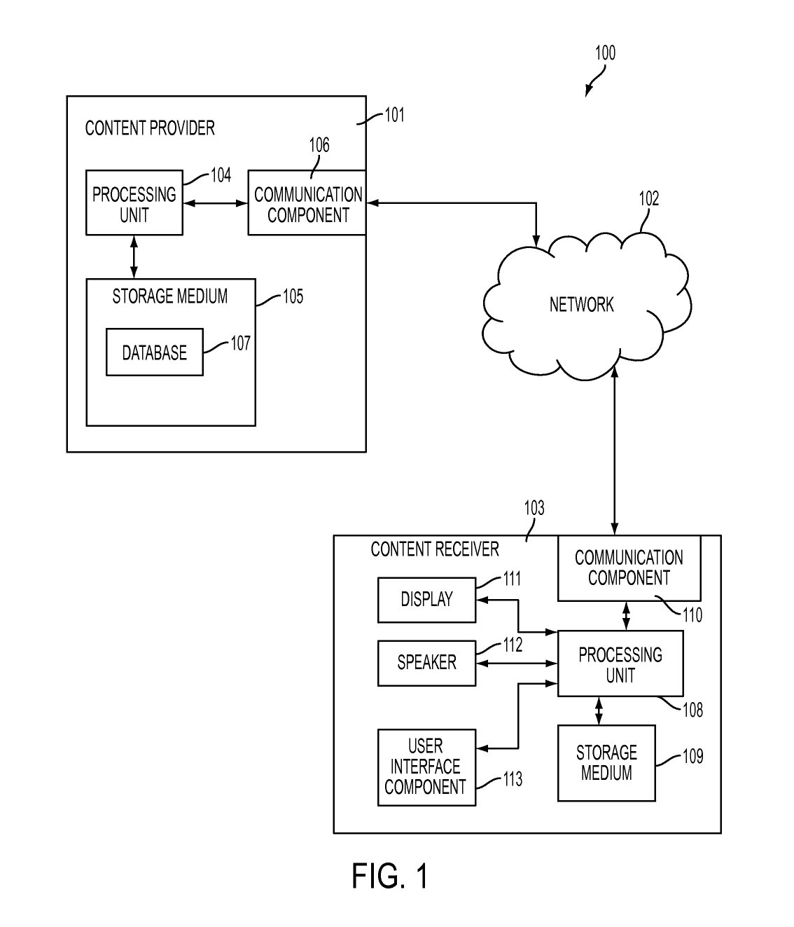

FIG. 1 depicts a block diagram of an example content delivery system 100 configured for generating content recommendations. The example content delivery system may include a computing device 101 (such as a head end) of a content provider (such as a satellite, cable, Internet, or other content provider that is communicably connected to one or more content receivers 103 (such as a set top box, a television, a computing device, or other content receiver) via a communication networks 102 (such as a satellite communication network, a cable communication network, a cellular communication network, the Internet, and so on).

The computing device 101 may include one or more processing units 104, one or more communication components 106, and one or more non-transitory storage media 105 (which may take the form of, but is not limited to, a magnetic storage medium; optical storage medium;

magneto-optical storage medium; read only memory; random access memory; erasable programmable memory; flash memory; and so on). The non-transitory storage media may store a database 107 or other data storage structure of instances of content (such as one or more movies, television shows, advertisements, audio, video, music, and so on) and/or metadata regarding the instances of content (which may be stored in the instances of content and/or separate from the instances of content).

Although the instances of content are described as stored in the database 107 of the computing device 101, it is understood that this is an example. In various implementations, the instances of content may be stored by one or more other computing devices accessible by the computing device without departing from the scope of the present disclosure.

The content receiver 103 may be any electronic device (such as a set top box, a desktop computer, a laptop computer, a mobile device, a smart phone, a cellular telephone, a tablet computer, a digital media player, and so on) capable of requesting and/or presenting content received from the computing device 101. The content receiver may include one or more processing units 108, one or more non-transitory storage media 109, one or more communication components 110, one or more output components for presenting content received from the head end such as one or more displays 111 and/or speakers 112, and/or one or more user input components 113 (such as one or more keyboards, mice, remote controls, buttons, and so on).

A user interface for generating one or more content recommendations in accordance with the present disclosure may be provided via the content receiver 103. In some implementations, the computing device 101 may generate the user interface, provide the user interface to the content receiver for presentation to the user, and/or receive user input related to the user interface from the content receiver. In other implementations, the content receiver may perform these functions and/or may perform these functions utilizing data obtained from the computing device. In still other implementations, these functions may be performed cooperatively by the computing device and the content receiver.

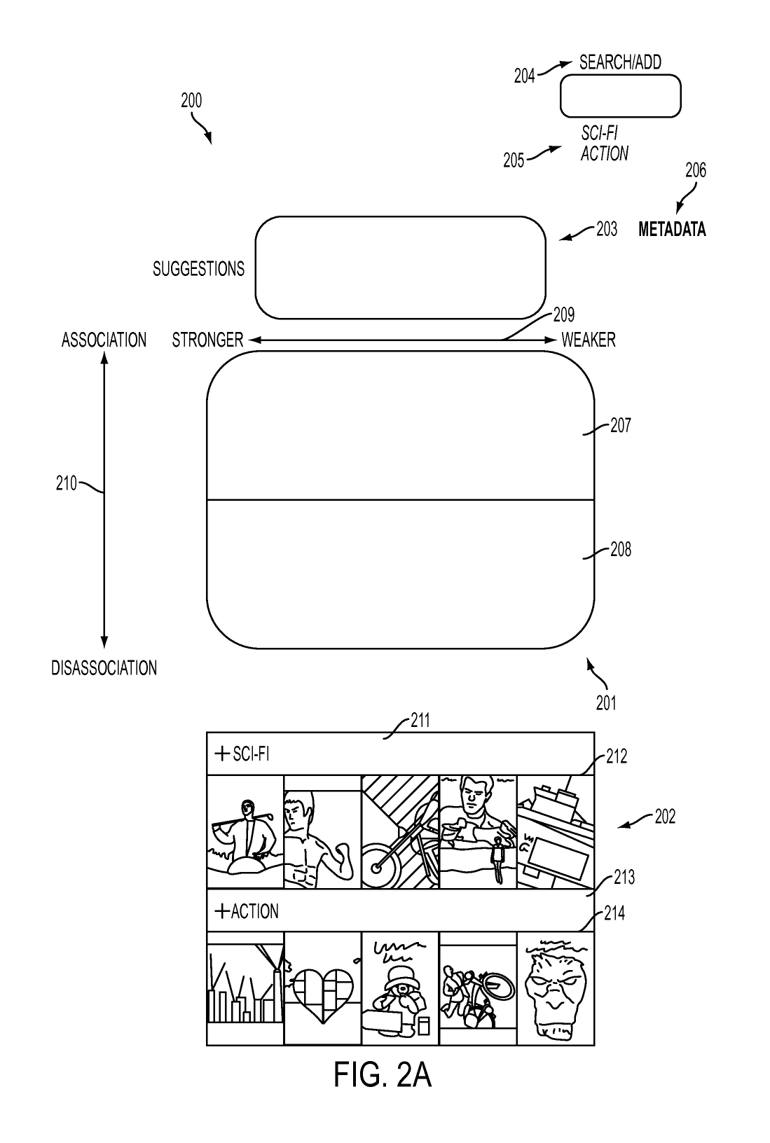

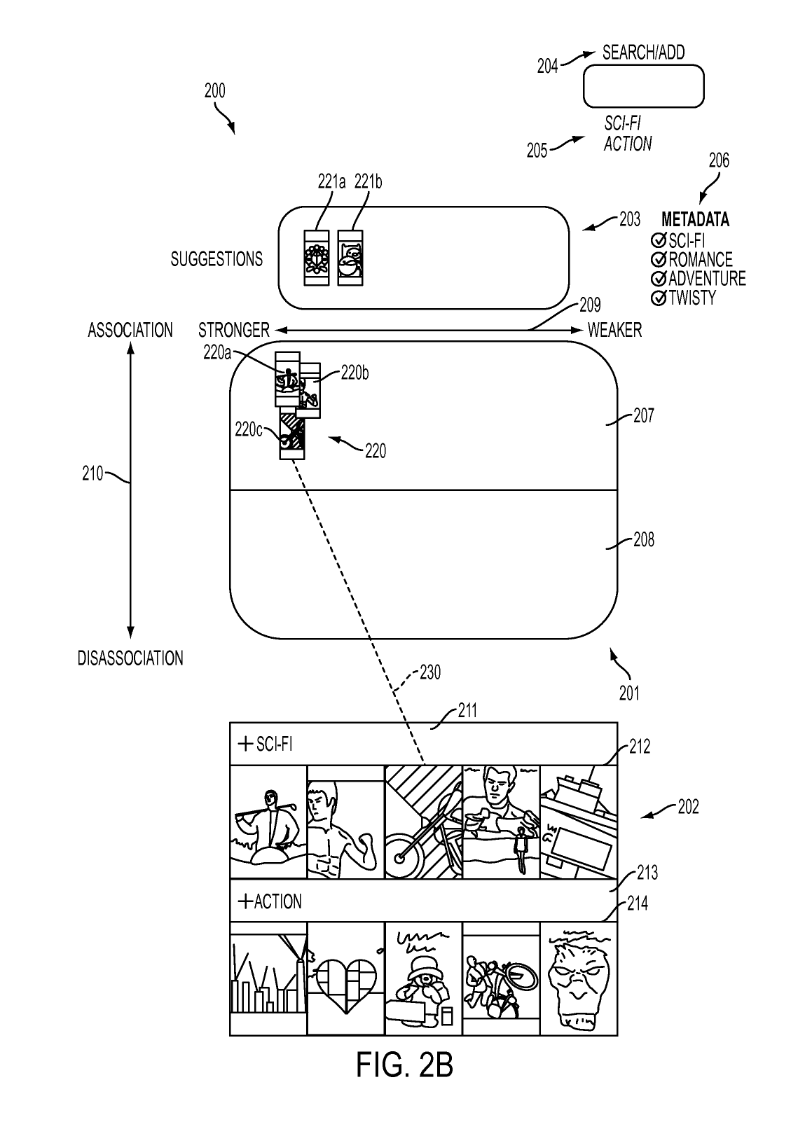

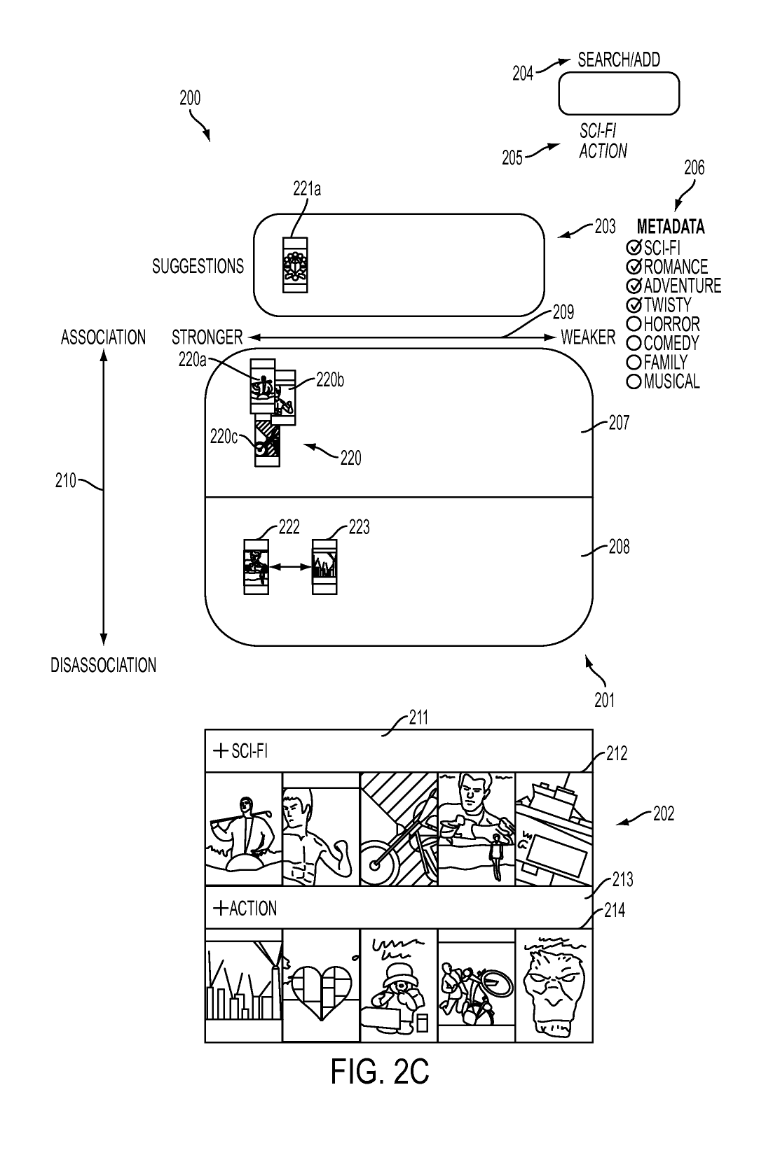

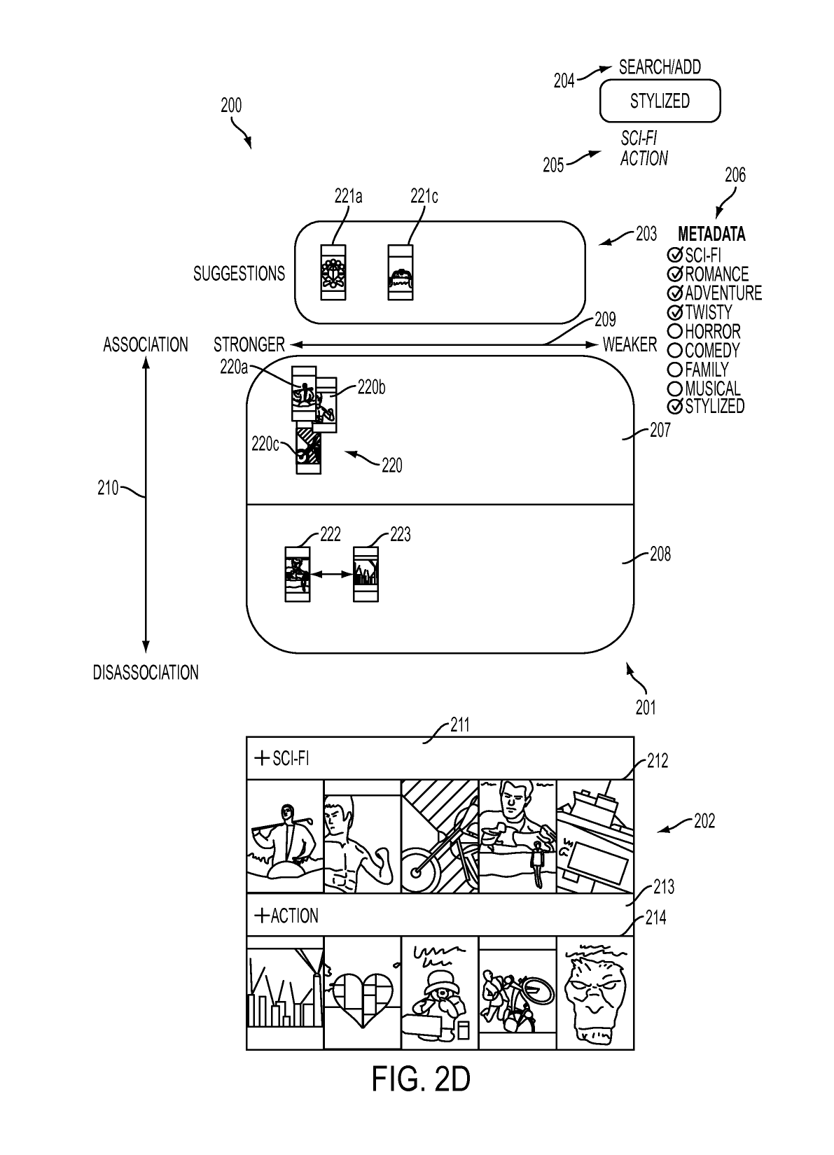

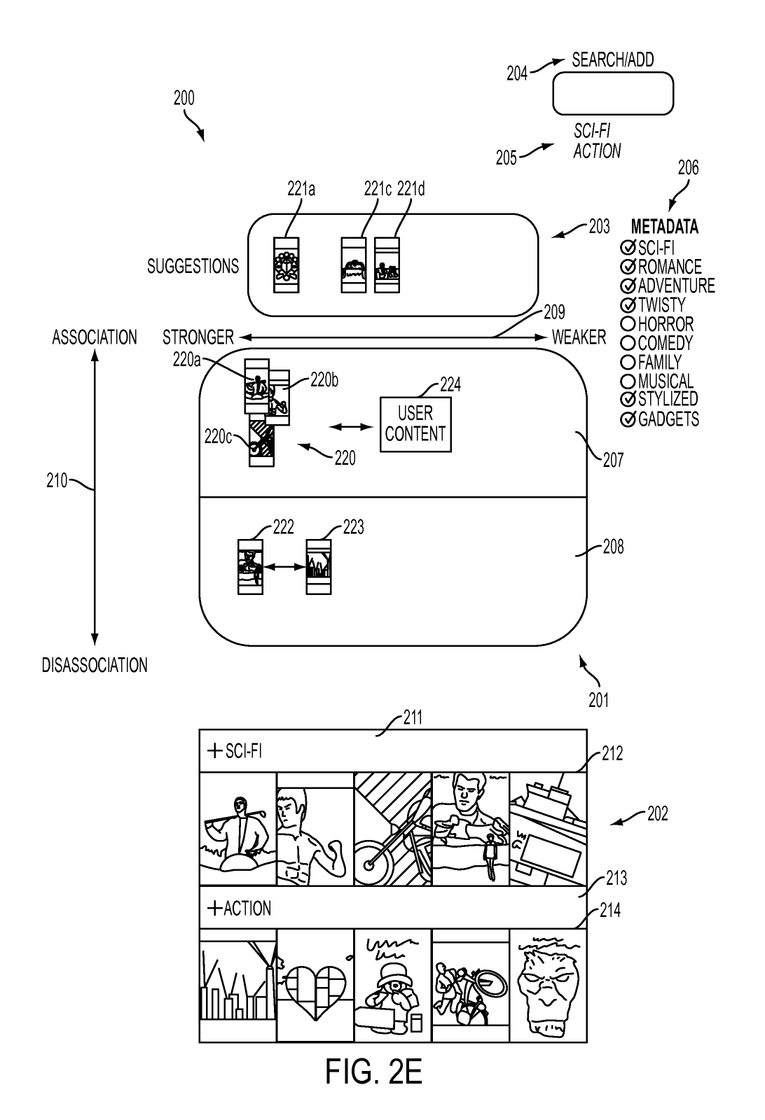

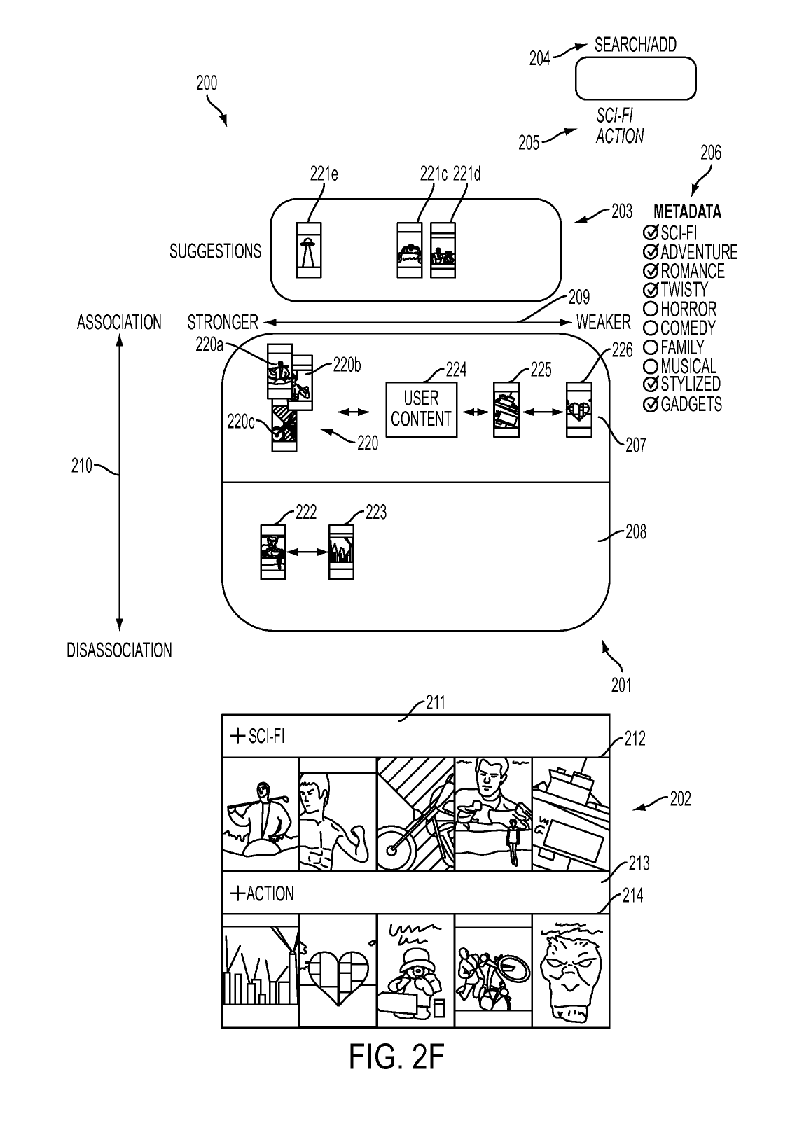

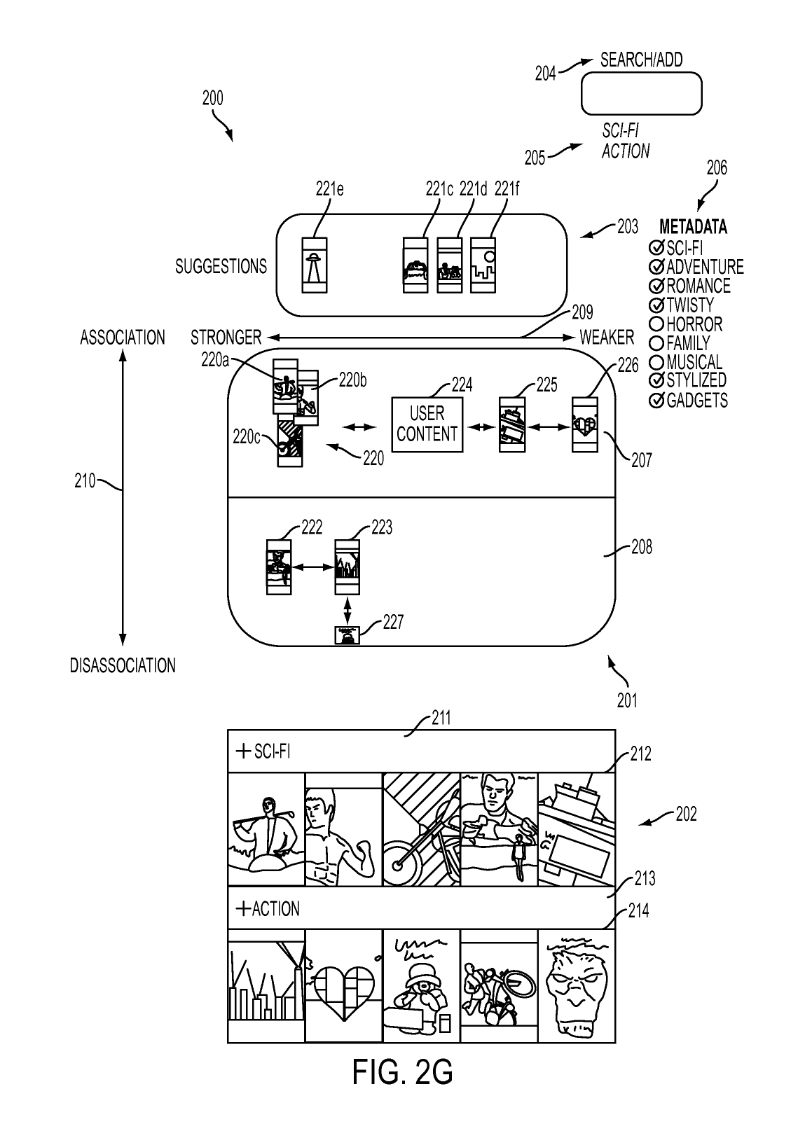

FIGS. 2A-2G depict diagrams of a sample user interface 200 for generating content recommendations. Such a user interface may be provided by the computing device 101 and/or the content receiver 103.

FIG. 2A illustrates the user interface 200 prior to the addition of any graphical representations of any instances of content. As illustrated, the user interface may include a window 201 where graphical representations of content may be positioned. The window may include an inclusion region 207 and an exclusion region 208. The window may have a variety of positions related to direction 209, which extends from a stronger position to weaker position (illustrated as left to right, stronger association to weaker association for the inclusion region and stronger disassociation to weaker disassociation for the exclusion region), and direction 210, which includes the association position of the inclusion region and the disassociation position of the exclusion region. Although the direction 210 is shown as either association (corresponding to the inclusion region) or disassociation (corresponding to the exclusion region) in a binary fashion, it is understood that this is an example and that in some implementations the direction 210 may be continuum between association and disassociation without departing from the scope of the present disclosure.

The user interface 200 may also include a suggestion window 203 (currently illustrated as empty because no data is present upon which to base a recommendation), a search/add box 204, a previous search link list 205 (which may include links to previous available content searches entered into the search/add box), a ranked list of metadata 206 that may be used to generate content recommendations (shown currently as empty), and available content window 202 (which may present available content based on a search entered into the search/add box).

As illustrated, the previous search link list 205 is illustrated as indicating that searches have been performed for “SCI-FI” content and “ACTION” content. As also illustrated, the available content window includes a first available content set 211 labelled “SCI-FI” including various available instances of Sci-Fi content 212 and a second available content set 213 labelled “ACTION” including various available instances of action content 214.

FIG. 2B illustrates the user interface 200 after graphical representations of a number of instances of available content 220a-220c have been selected and moved (“dragged,” as illustrated by the example dashed line 230) from the first available content set 211 and/or the second available content set 213 to the inclusion region 207. As shown, the graphical representations have been grouped together or “stacked” at the same position. As such, the instances of available content 220a-220c may be treated as a single instance of content 220 with a set of metadata that is common to the individual instances 220a-220c. Also, as the group 220 is located close to the strong association position on the direction 209 in the inclusion region 207, that set of metadata may be ranked highly for inclusion. This metadata is shown listed as in the ranked metadata list 206.

As shown, the ranked metadata list 206 now includes entries for “SCI-FI,” “ROMANCE,” “ADVENTURE,” and “TWISTY.” These may be categories indicated in metadata common to the content 220a-220c. As shown, the items in the ranked metadata list include checkboxes. These checkboxes may indicate whether an item of metadata is inclusionary (to be used in generating the content recommendation) when checked or exclusionary (to be excluded when generating the content recommendation) when unchecked. As the content 220 is positioned in the inclusion region 207, the check boxes for “SCI-FI,” “ROMANCE,” “ADVENTURE,” and “TWISTY” are all checked. However, a user may uncheck any of these check boxes to exclude one of these metadata from the content recommendation generation.

The metadata in the ranked metadata list 206 may be utilized to search available content and generate one or more content recommendations. As such, content recommendations 221a-221b are shown displayed in suggestion window 203. One or more of these recommendations may be selected by a user. In response to such a selection, the associated content may be provided to the user.

FIG. 2C illustrates the user interface 200 after graphical representations of a number of instances of available content 222 and 223 have been selected and moved (“dragged”) from the first available content set 211 and/or the second available content set 213 to the exclusion region 208. As such, metadata associated with content 222 (in this example “HORROR”) and 223 (in this example “COMEDY,” “FAMILY,” and “MUSICAL”) may be ranked for exclusion. As content 222 is closer to the strong disassociation position of the exclusion region, metadata associated with the content 222 (in this example “HORROR”) may be ranked higher for exclusion than metadata associated with the content 223 (in this example “COMEDY,” “FAMILY,” and “MUSICAL”). As illustrated, the ranked metadata list 206 has been updated for the metadata associated with content 222 and 223, shown as “HORROR,” “COMEDY,” “FAMILY,” and “MUSICAL.” The checkboxes for these items are shown as unchecked, indicating that they will be excluded (though a user can override this by checking the check boxes). Correspondingly, the content recommendation 221b has been removed from the suggestion window 203 as a result of adding content 222 and 223 to the exclusion region.

FIG. 2D illustrates a user adding metadata to the ranked metadata list 206 independent of content depicted in the window 201 via the search/add box 204. As illustrated, the user added the metadata “Stylized,” which was then added with a corresponding checked check box to the ranked metadata list. Based on these modifications to the user interface 200, a content recommendation 221c has been added to the suggestion window 203.

FIG. 2E illustrates a user adding a graphical representation 224 of content provided by the user. For example, the user may upload an image and/or other content from the user's computer, phone, or other device. The user provided content may already include metadata when provided, or the user interface 200 may enable the user to add (as well as delete or modify) metadata associate with the user provided content (as well as the available content and/or any content depicted in the window 201). As illustrated, the user content 224 may be an image of a gadget and include metadata indicating such. Thus, the ranked metadata list 206 is updated to include “Gadgets” with a corresponding checked check box. Based on these modifications to the user interface, a content recommendation 221d has been added to the suggestion window 203.

FIG. 2F illustrates the addition of content 225 and 226 to the inclusion region 207. In this example, content 225 and 226 do not include metadata additional to that of content 220. As such, no additional metadata is added to the list 206. Content 225 and 226 may both include an Actor X but metadata may indicate that content 225 is an adventure whereas content 226 is a romance. As Actor X is associated with both content 225 and 226, the relatively large distance shown between the positions of content 225 and 226 and the association of content 225 with adventure and content 226 with romance indicates to rank the “ADVENTURE” metadata higher than the “ROMANCE” metadata. As shown, the ranked metadata list 206 is updated to rank the “ADVENTURE” metadata higher than the “ROMANCE” metadata. As also shown, this causes the recommendation 221a to be replaced with 221e.

FIG. 2G illustrates the addition of the graphical representation of an instance of content 227 below the content 223 in the exclusion region 207. In this implementation, such a vertical arrangement as opposed to horizontal (perpendicular to the direction 209) may subtract the metadata found the content 227 from the content 223 and treat the disjoined set of metadata as the metadata for a single instance of content. Thus, a user may be able to fine tune precisely the metadata the user wishes to exclude.

For example, content 223 may have the metadata “COMEDY,” “FAMILY,” and “MUSICAL” whereas the content 227 has the metadata “COMEDY.” As such, “COMEDY” is subtracted from the metadata of the content 223 and is thus removed from the ranked metadata list 206. As a result, the content recommendation 221f has been added to the suggestion window 203.

Although FIGS. 2A-2G illustrate various configurations, operations, and manipulations of a user interface 200, it is understood that these are examples. In various implementations, a user interface may be configured differently, perform different operations, and be manipulated in a different fashion without departing from the scope of the present disclosure. Various arrangements are possible and contemplated.

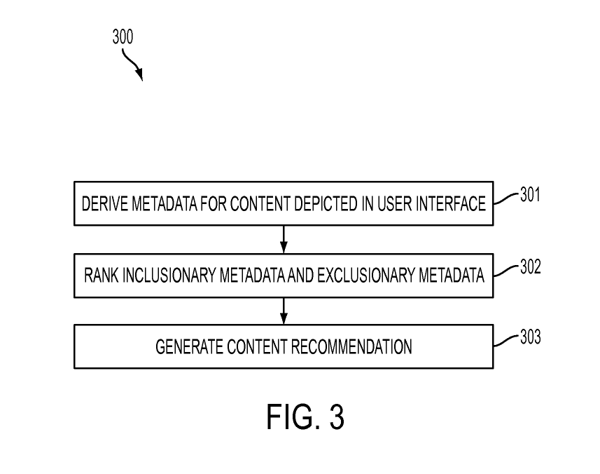

FIG. 3 depicts a method diagram illustrating operations of a first example method 300 of generating content recommendations. The method may be performed by the computing device 101 and/or the content receiver 103 of FIG. 1.

The method may begin at 301 with the operation of deriving metadata for content depicted by graphical representations presented in a user interface.

Thereafter, at 302, the method may continue with the operation of ranking inclusionary metadata (or metadata for which to search) and exclusionary metadata (or metadata which to exclude from a search) based on the positions of the graphical representations of the content in the user interface.

Thereafter, at 303, the method may continue with the operation of generating a content recommendation based at least upon the ranking.

Although the example method 300 is illustrated and described above as including particular operations performed in a particular order, it is understood that this is an example. In various implementations, various orders of the same, similar, and/or different operations may be performed without departing from the scope of the present disclosure.

For example, the operation 302 is illustrated and described as ranking both inclusionary metadata and exclusionary metadata based on the positions of the graphical representations of the content in the user interface. However, in some cases the positions of the graphical representations of the content in the user interface may indicate not to utilize any inclusionary metadata or any exclusionary metadata. In such a case, the operation of ranking may rank only inclusionary metadata or exclusionary metadata without ranking both. By way of illustration, FIG. 2B illustrates ranking of only inclusionary metadata.

By way of another example, the example method is illustrated and described above as performing the operations 301 and 302 of deriving and ranking the metadata. However, in various cases an operation of obtaining such a ranking may be performed instead of performing operations 301 and 302 without departing from the scope of the present disclosure.

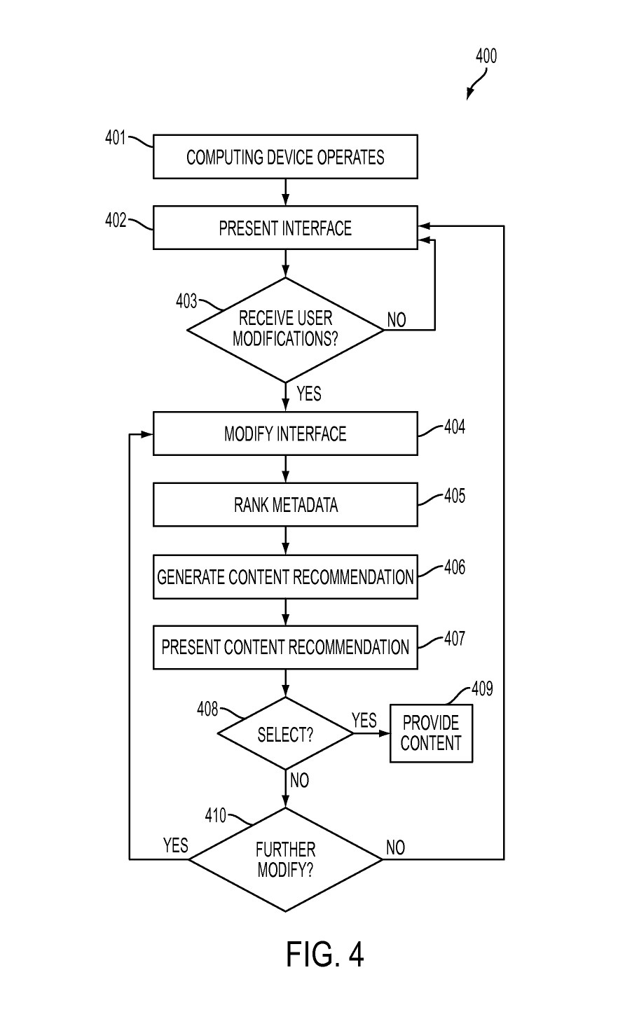

FIG. 4 depicts a flow chart illustrating operations of a second example method 400 of generating content recommendations. The method may be performed by the computing device 101 and/or the content receiver 103 of FIG. 1.

The method may begin at 401 where a computing device operates. The flow may proceed to block 402 where a user interface for generating content recommendations may be presented.

The flow may then proceed to 403 where determines whether or not one or more user modifications to the user interface are received. Such modifications may include the addition of graphical representations of content (such as selection from a list of available content or content representations, content provided by a user, and so on), searching for content, the removal of graphical representations of content, the positioning of included graphical representations of content, the addition of metadata, the modification of metadata, the removal of metadata, and so on. If so, the flow may proceed to block 404. Otherwise, as the user interface may not yet include any data upon which to base content recommendations, the flow may return to block 402 where presentation of the user interface continues until user modifications are received.

At block 404, after user modifications to the user interface are received, the user interface may be modified accordingly. The flow may then proceed to block 405 where metadata associated with content corresponding to graphical representations included in the graphical interface is ranked. The ranking may be based upon the position of the graphical representations and/or the positional relationships between the graphical representations. The ranking may include ranking of inclusionary metadata and/or exclusionary metadata. The flow may then proceed to block 406.

At block 406, a content recommendation may be generated based at least upon the ranking of the metadata. Content with metadata meeting the ranked metadata (in the case of inclusionary metadata) and/or not meeting the ranked metadata (in the case of exclusionary metadata) may be selected. The flow may then proceed to block 407 where the content recommendation may be presented.

At block 408, after the content recommendation is presented, it may be determined whether or not the content recommendation is selected. If so, the flow may proceed to block 409 where content associated with the content recommendation may be provided. Otherwise, the flow may proceed to block 410.

At block 410, it may be determined whether or not further modifications to the user interface are received. If so, the flow may return to block 404 where the user interface is accordingly further modified. Otherwise, the flow may return to block 402 where the providing of the user interface may continue.

Although the example method 400 is illustrated and described above as including particular operations performed in a particular order, it is understood that this is an example. In various implementations, various orders of the same, similar, and/or different operations may be performed without departing from the scope of the present disclosure.

For example, operation 403 is illustrated and described as returning to operation 402 if no user modifications to the user interface are received as no data may be present upon which a content recommendation may be based. However, in various implementations default data may be included in the user interface upon which recommendations may be based in the absence of user modifications to the user interface. Such default data may be based on previous content accesses of the user, data in a user profile and/or other data regarding the user, and so on. In such an implementation, if no user modifications are received a content recommendation based on the default data may be generated. The content recommendation may then be subsequently updated if user modifications are later received. Various configurations are possible without departing from the scope of the present disclosure.

By way of another example the method 400 is illustrated and described as ranking the metadata at block 405. However, in various implementations such a ranking may be obtained from another device, retrieved from storage, and/or otherwise received without departing from the scope of the present disclosure.

As described above and illustrated in the accompanying figures, the present disclosure details methods, systems, and apparatuses for generating content recommendations. A computing device presents a user interface in which graphical representations of content may be positioned based on user input. Inclusionary and exclusionary portions of metadata associated with the content is ranked based on the positions and/or positional relationships of the graphical representations in the user interface. The computing device generates content recommendations based on the rankings. Presented content associated with the content recommendations may be provided to a user in response to selection of a content recommendation. The content recommendations may be modified in response to changes to the user interface received from a user. In this way, content recommendations may be generated in a manner that is controllable by a user without overly burdening the user.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

Although embodiments which incorporate the teachings of the present disclosure have been shown and described in detail herein, those skilled in the art can readily devise many other varied embodiments that still incorporate these teachings. Having described preferred embodiments of a system, method and user interface for content search (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method for generating a content recommendation, comprising:
obtaining, a ranking of an inclusionary portion of metadata derived from instances of content for which graphical representations are presented in a user interface and an exclusionary portion of the metadata, the metadata ranked based on positions of the graphical representations in the user interface;
generating a content recommendation based on the ranking of the inclusionary portions of the metadata and the exclusionary portions of the metadata; and
modifying the metadata from the instances of content based on user input.

2. The method of claim 1, further comprising presenting the content recommendation via the user interface.

3. The method of claim 2, further comprising providing a requested instance of content in response to receiving a selection of the presented content recommendation.

4. The method of claim 1, wherein:
the inclusionary portion of the metadata is derived from a first number of the instances of content for which graphical representations are located in an inclusion region; and
the exclusionary portion of the metadata is derived from a second number of the instances of content for which graphical representations are located in an exclusion region.

5. The method of claim 4, wherein the ranking of the inclusionary portions of the metadata and the exclusionary portions of the metadata ranks at least one of:
a first item of the inclusionary portion of the metadata higher than a second item of the inclusionary portion of the metadata when a graphical representation of a first instance of content associated with the first item of the inclusionary portion of the metadata is located closer along a direction to a strong association position of the inclusion region than a graphical representation of a second instance of content associated with the second item of the inclusionary portion of the metadata; or
a first item of the exclusionary portion of the metadata higher than a second item of the exclusionary portion of the metadata when a graphical representation of a third instance of content associated with the first item of the exclusionary portion of the metadata is located closer along the direction to a strong disassociation position of the exclusion region than a graphical representation of a fourth instance of content associated with the second item of the exclusionary portion of the metadata.

6. The method of claim 4, wherein the ranking of the inclusionary portions of the metadata and the exclusionary portions of the metadata ranks at least one of:
an item of the inclusionary portion of the metadata associated with a graphical representation of a first instance of content higher when the graphical representation of the first instance of content is more proximate to a graphical representation of a second instance of content that is closer in a direction to a strong association position of the inclusion region than when the graphical representation of the first instance of content is less proximate to the graphical representation of the second instance of content; or
an item of the exclusionary portion of the metadata associated with a graphical representation of a third instance of content higher when the graphical representation of the third instance of content is more proximate to a graphical representation of a fourth instance of content that is closer in the direction to a strong disassociation position of the exclusion region than when the graphical representation of the third instance of content is less proximate to the graphical representation of the fourth instance of content.

7. The method of claim 1, wherein the ranking of the inclusionary portions of the metadata and the exclusionary portions of the metadata treats metadata common to multiple instances of content as a single set when graphical representations of the multiple instances of content are grouped together at a same position in the user interface.

8. The method of claim 1, further comprising positioning a graphical representation of one of the instances of content in the user interface in response to user input.

9. The method of claim 8, wherein the graphical representation of the one of the instances of content is one of selected from an available content region of the user interface or provided by a user.

10. (canceled)

11. A computing device, comprising:
at least one processor; and
a memory coupled to the at least one processor, the memory for storing instructions which, when executed by the processor, performs a method for generating a content recommendation, the method comprising:
obtaining a ranking of an inclusionary portion of metadata derived from instances of content for which first graphical representations are presented in an inclusion region of a user interface and an exclusionary portion of the metadata derived from instances of content for which second graphical representations are presented in an exclusion region of the user interface, the metadata ranked based on positions of the first and second graphical representations in the user interface;
generating a content recommendation based on the ranking of the inclusionary metadata and the exclusionary metadata; and
modifying at least one of the inclusionary metadata or the exclusionary metadata based on a user response to presentation of the inclusionary metadata and the exclusionary metadata.

12. (canceled)

13. The computing device of claim 11, wherein the presentation of the inclusionary metadata and the exclusionary metadata presents the inclusionary metadata and the exclusionary metadata in ranked order.

14. The computing device of claim 11, wherein the ranking ranks a first item of the inclusionary metadata common to more of the instances of content for which the first graphical representations are presented in the inclusion region than a second item of the inclusionary metadata common to fewer of the instances of content for which the first graphical representations are presented in the inclusion region.

15. The computing device of claim 11, wherein the generating of the content recommendation is further based on user supplied metadata.

16. A computer program product, tangibly embodied in a non-transitory computer-readable storage medium, comprising:
a first set of instructions, stored in the non-transitory computer-readable storage medium, executable by a processing unit to provide a user interface;
a second set of instructions, stored in the non-transitory computer-readable storage medium, executable by the processing unit to position graphical representations of instances of content in the user interface according to input received from a user; and
a third set of instructions, stored in the non-transitory computer-readable storage medium, executable by the processing unit to generate a content recommendation based on rankings of inclusionary metadata and exclusionary metadata associated with the instances of content, the rankings determined based on the positions of the graphical representations in the user interface, wherein the inclusionary metadata and exclusionary metadata comprises a category of content.

17. The computer program product of claim 16, wherein the ranking of an item of metadata is related to a location of a graphical representation of an instance of content of the instances of content along a first direction.

18. The computer program product of claim 17, wherein a set of metadata not common to two instances of content is treated as metadata for a single instance of content when graphical representations for the two instances of content are positioned along a second direction perpendicular to the first direction.

19. (canceled)

20. The computer program product of claim 16, further comprising a fourth set of instructions, stored in the non-transitory computer-readable storage medium, executable by the processing unit to generate an additional content recommendation after modifying the user interface in response to additional input received from the user.

21. A user interface, comprising:
a display device having a first display panel region, a second display panel region and a third display panel region; and
a processor being configured to display in said first display panel region at least a first pair of user selected image representations, each representing a corresponding content having associated metadata, said processor being additionally configured to display in said second display panel region a second image representation representing content having associated metadata and said processor being further configured to display in said third display panel region at least a third image representation representing recommended content having associated metadata, said metadata associated with said at least third image representation being selected to enhance inclusion therein of inclusionary metadata associated with a given image representation displayed in one of said first and second display panel regions,
said metadata associated with said at least third image representation being selected to enhance exclusion therefrom of exclusionary metadata associated with a given image representation displayed in the other one of said first and second display panel regions and said metadata associated with said at least third image representation being selected to enhance the applicable inclusionary metadata inclusion and exclusionary metadata exclusion associated with said at least pair of image representations in accordance with an order of presentation of said at least pair of image representations within said first display panel region, wherein, in response to a user input, said processor is configured to change an individual category of metadata from being included in said listing to being excluded from said listing, and vice versa, and wherein said at least said metadata associated with said at least third image representation is selected in accordance with said changed listing.

22. A user interface according to claim 21 wherein said processor is configured to display in said second display panel region at least a second pair of user selected image representations that includes said second image and wherein said metadata associated with said at least third image representation is selected to enhance the applicable inclusionary metadata inclusion therein and exclusionary metadata exclusion therefrom associated with said at least second pair of image representations in accordance with an order of presentation of said at least second pair of image representations within said second display panel region.

23. A user interface in accordance with claim 21 wherein said a processor is configured to display in a fourth region of said display panel a listing of said inclusionary metadata and said exclusionary metadata.

24. A user interface in accordance with claim 21 wherein said a processor is configured to display in a fourth region of said display panel a plurality of image representations and, in response to a user input, said processor is configured to transfer at least a copy of one of said plurality of image representations from said fourth region to one of said first and second regions in a dragging manner that results in a change in said metadata associated with said at least third image representation.

25. A user interface in accordance with claim 21 wherein said metadata associated with said at least third image representation is selected to further enhance the applicable inclusionary metadata inclusion and exclusionary metadata exclusion associated with said at least pair of image representations in accordance with a sum total of occurrences of an identical category of metadata in said in said at least pair of image representations displayed within said first display panel region.
